(19) United States
(12) Patent Application Publication
(10) Pub. No.: US 2008/0246744 A1
(43) Pub. Date: Oct. 9, 2008

(54) Touch-screen display device

(75) Inventors: Sung-Hwan Park, Yongin-si (KR); Ki-Sik Park, Suwon-si (KR); Kyung-Ho Hwang, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd

(21) Appl. No.: 12/082,310

(22) Filed: Apr. 9, 2008

(30) Foreign Application Priority Data
Apr. 9, 2007 (KR) 10-2007-0034651

(51) Int. Cl. G06F 3/041

(52) U.S. Cl. 345/173

(57) ABSTRACT

A touch-screen display device includes a touch panel and a display panel. The touch panel includes a signal terminal portion transmitting a coordinate signal corresponding to a touch position. The display panel is disposed under the touch panel, and includes a display area and a peripheral area that surrounds the display area. An image is displayed in the display area. A first terminal portion is disposed in the peripheral area and electrically connected to the signal terminal portion. Thus, the first terminal portion is formed on the display panel, and thus the coordinate signal may be directly transmitted to a main flexible printed circuit board (FPCB) through the first terminal portion, so that the coordinate signal may be stably transmitted.

### CROSS-REFERENCE TO RELATED APPLICATION

The present application claims priority under 35 U.S.C. §119 to Korean Patent Application No. 2007-34651, filed on Apr. 9, 2007 in the Korean Intellectual Property Office (KIPO), the contents of which are herein incorporated by reference in their entirety.

### BACKGROUND OF THE INVENTION

1. Field of the Invention

The present invention relates to a display device. More particularly, the present invention relates to a touch-screen display device having enhanced reliability.

2. Description of the Related Art

Generally, a display device converts electrical signals that are provided from an information processing device into images. Conventional display devices and information processing devices typically communicate unidirectionally. Therefore, in order to display new images on the display device, a data input device, such as a keyboard, a keypad, a mouse apparatus, etc., has been required.

Recently, information processing devices that directly receive information on a screen of the display device have been developed. For example, a touch-screen display device includes a display and a touch panel that further includes a position detecting sensor.

The display panel is connected to a main flexible printed circuit board (FPCB) on which a driving chip is mounted to drive the display panel. The touch panel is connected to the FPCB that transmits a coordinate signal corresponding to a touch position to the main FPCB.

The FPCB that is bent toward the outermost surface of the display panel is received in a receiving container such as a bottom chassis, etc., in a process of assembling the display device. However, one or more of the wires of the FPCB may be cut in the FPCB in the process of assembly, thereby degrading functionality of the touch panel.

### SUMMARY OF THE INVENTION

The present invention provides a touch-screen display device for enhancing the reliability of a product.

In one aspect of the present invention, a touch-screen display device includes a touch panel and a display panel. The touch panel includes a signal terminal portion transmitting a sensed coordinate signal corresponding to a touch position. The display panel is disposed under the touch panel, and includes a display area, and a peripheral area that surrounds the display area. An image is displayed in the display area. A first terminal portion of the display panel is disposed in the peripheral area and electrically connected to the signal terminal portion.

According to the touch-screen display device, a first terminal portion is formed on a display panel, which is electrically connected to a signal terminal portion outputting a coordinate signal detected from a touch panel, and thus the coordinate signal is directly transmitted to the main flexible printed circuit board (FPCB). Thus, the coordinate signal may be stably transmitted.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view illustrating a touch-screen display device according to a first exemplary embodiment of the present invention;

FIG. 2 is an enlarged plan view illustrating a first lower substrate of FIG. 1;

FIG. 3 is a plan view illustrating the touch-screen display device of FIG.1;

FIG. 4 is a cross-sectional view taken along a line I-I′ of FIG.3;

FIG. 5 is a plan view illustrating a touch-screen display device according to a second exemplary embodiment of the present invention;

FIG. 6 is a cross-sectional view taken along a line II-II′ of FIG. 5;

FIG. 7 is an exploded perspective view illustrating a touch-screen display device according to a third exemplary embodiment of the present invention;

FIG. 8 is plan view illustrating the touch-screen display device of FIG. 7;

FIG. 9 is a cross-sectional view taken along a line III-III′ of FIG. 8; and

FIG. 10 is a cross-sectional view illustrating a touch-screen display device according to a fourth exemplary embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

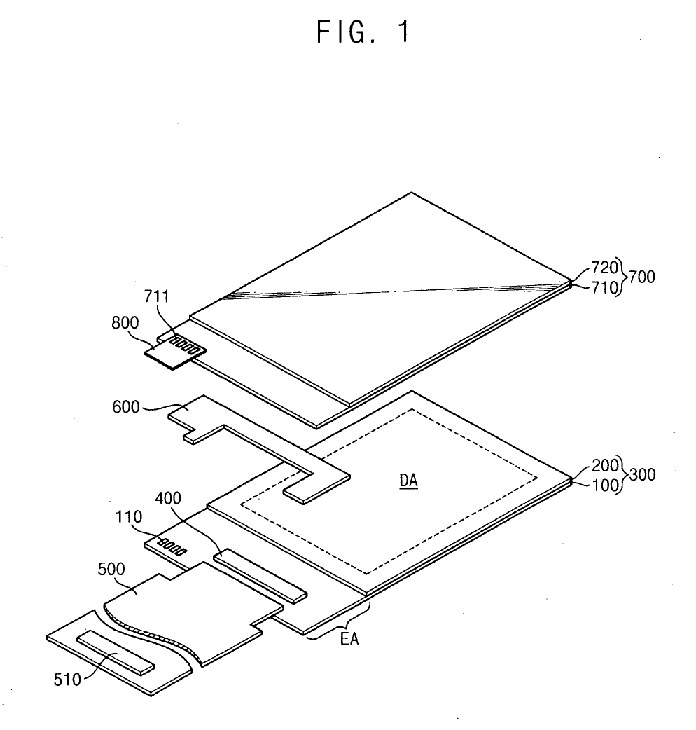

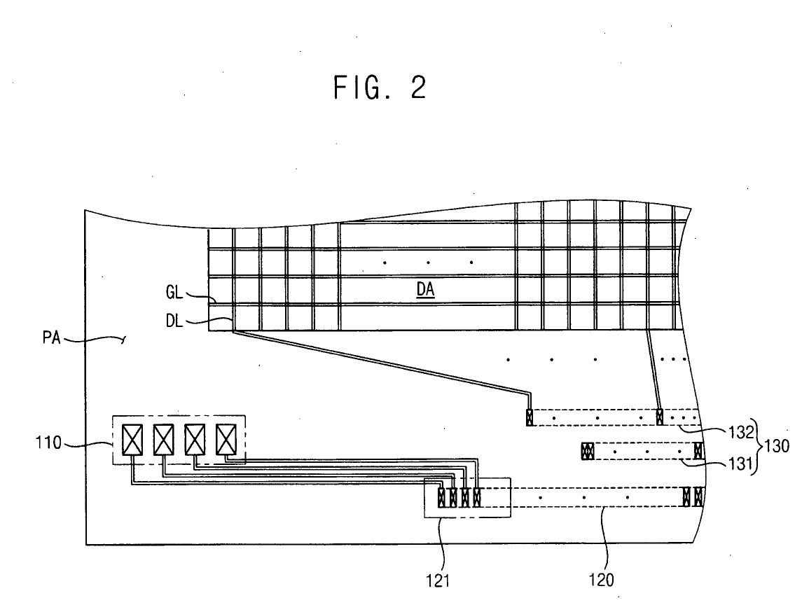

FIG. 1 is an exploded perspective view illustrating a touch-screen display device according to a first exemplary embodiment of the present invention. FIG. 2 is an enlarged plan view illustrating a first lower substrate of FIG. 1.

Referring to FIGS. 1 and 2, a touch-screen display device includes a display panel 300, a driving chip 400, a main flexible printed circuit board (FPCB) 500, a reinforcing member 600, a touch panel 700 and a sub-FPCB 800.

The display panel 300 includes a first lower substrate 100 and a first upper substrate 200. The first lower substrate 100 includes a display area DA and a peripheral area that surrounds the display area, as shown in FIG. 2. A plurality of gate lines GL, a plurality of data lines DL crossing the gate lines GL and a plurality of pixel portions are formed in the display area DA.

A first terminal portion 110, a second terminal portion 120 and a third terminal portion 130 are formed in a portion of the peripheral area PA corresponding to an end portion of the data lines DL.

The first terminal portion 110 is electrically connected to a signal terminal portion 711 that is formed on the touch panel and receives a coordinate signal corresponding to a touch position sensed from the touch panel 700. Hereinafter, the first terminal portion 110 will be referred to as a touch-screen panel (TSP) terminal portion 110.

The second terminal portion 120 is electrically attached to the main FPCB 500 and receives a driving signal provided from a main driving circuit 510 that is electrically attached to the main FPCB 500 to drive the display panel 300.

The second terminal portion 120 includes the TSP terminal portion 110 and an output terminal portion 121. The output terminal portion 121 transmits the coordinate signal that is applied to the TSP terminal portion 110 toward the main driving circuit 510 through the main FPCB 500. Hereinafter, the second terminal portion 120 will be referred to as a flexible printed circuit (FPC) terminal portion 120.

The third terminal portion 130 is electrically attached to a terminal portion of the driving chip 400. The third terminal portion 130 includes a plurality of input terminals 131 that is connected to a plurality of input terminals of the driving chip 400 and a plurality of output terminals 132 that are connected to a plurality of output terminals of the driving chip 400. An input signal is applied to the driving chip 400 through the input terminals 131. The output terminals 132 are electrically connected to the data lines DL formed on the display area, respectively, and provide an output signal from the driving chip 400 to the data lines DL. Hereinafter, the third terminal portion 130 will be referred to as an integrated circuit (IC) terminal portion 130.

The first upper substrate 200 is combined with the first lower substrate 100, and is overlapped with the display area DA of the first lower substrate 100. A liquid crystal layer (not shown) is disposed between the first upper substrate 200 and the first lower substrate 100. The first upper substrate 200 may include a plurality of color filters corresponding to the pixel portions, respectively, and a common electrode.

The driving chip 400 is disposed on the IC terminal portion 130. An anisotropic conductive film (ACF) is disposed between the IC terminal portion 130 and the driving chip 400, to electrically connect the IC terminal portion 130 with the driving chip 400.

The main FPCB 500 is disposed on the FPC terminal portion 120. The FPC terminal portion 120 is electrically attached to the main FPCB 500 by the ACF. The main driving circuit 510 may be disposed on the main FPCB 500, or may be disposed on a PCB that is electrically connected to the main FPCB 500.

The reinforcing member 600 is disposed on an exposure area EA, that is, a portion of the peripheral area PA of the first lower substrate 100, which is not overlapped with the first upper substrate 200. An adhesive material is disposed on at least one surface of the reinforcing member. For example, the reinforcing member 600 is an adhesive tape.

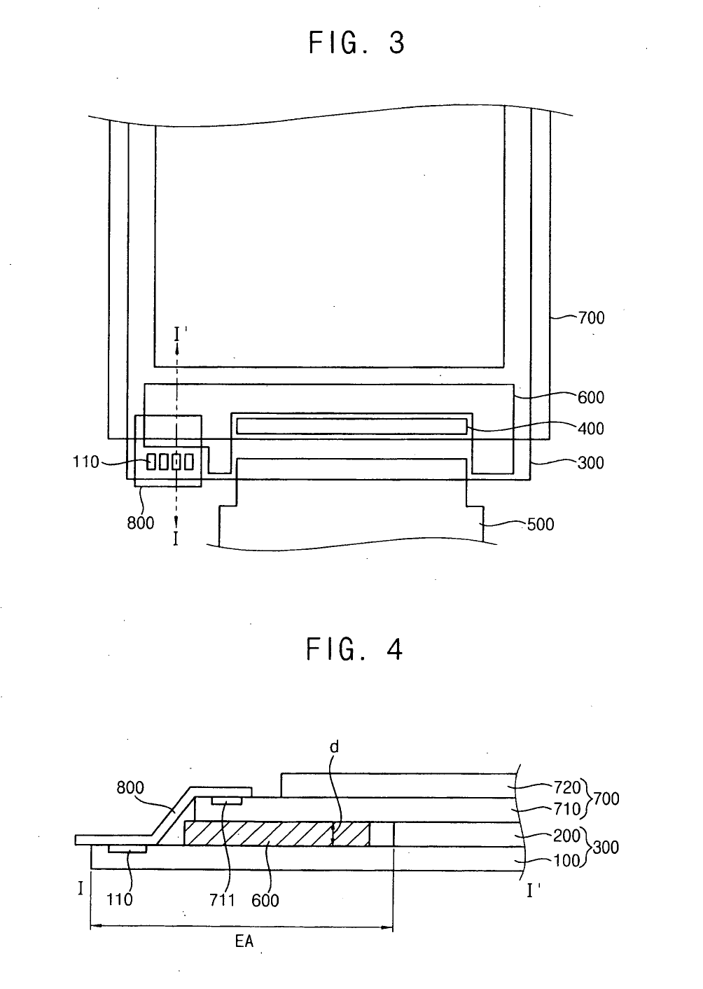

The reinforcing member 600 maintains a distance between the display panel 300 and the touch panel 700, and buffers against external impacts. A function of buffering against external impacts will be hereinafter explained referring to FIGS. 3 and 4.

In addition, the reinforcing member 600 is disposed on an area adjacent to the TSP terminal portion 110, the FPC terminal portion 120 and the IC terminal portion 130. The reinforcing member 600 may have conductive and/or insulating portions that protect the TSP terminal portion 110, the FPC terminal portion 120 and the IC terminal portion 130 from static electricity.

The touch panel 700 includes a second lower substrate 710 and a second upper substrate 720, and detects the coordinate signal corresponding to the touch position by a resistive overlay. For example, the second lower substrate 710 includes a lower plate electrode that detects a coordinate signal X of the touch position. The second upper substrate 720 includes an upper electrode that detects a coordinate signal Y of the touch position. The coordinate signal is transmitted to the signal terminal portion 711 formed on the second lower substrate 710.

The sub-FPCB 800 electrically connects the signal terminal portion 711 formed on the touch panel 700 with the TSP terminal portion 110 formed on the display panel 300. For example, the sub-FPCB 800 includes one end electrically attached to the signal terminal portion 711 of the touch panel 700 and the other end electrically connected to the TCP terminal portion 110 of the display panel 300. For example, the sub-FPCB 800 may be electrically connected to the signal terminal portion 711 and the TSP terminal portion 110 by ACF.

Thus, the sub-FPCB 800 transmits the coordinate signal transmitted from the signal terminal portion 711 of the touch panel 700 to the TSP terminal portion 110 of the display panel 300. The main FPCB 500 transmits the coordinate signal transmitted from the TSP terminal portion 110 of the touch panel 700 to the main driving circuit 510.

The touch-screen display device includes the display panel 300 that has the TSP terminal portion 110 and the output terminal portion 121 electrically connected to the TSP terminal portion 110. The TSP terminal portion 110 is electrically connected to the signal terminal portion 711 of the touch panel 700 and the output terminal portion 121 is electrically connected to the main FPCB 500.

The display panel has the TSP terminal portion 110 electrically connected to the signal terminal portion 711 outputting the coordinate signal, and thus the coordinate signal is directly transmitted to the main FPCB 500, so that the coordinate signal may be reliably transmitted.

FIG. 3 is a plan view illustrating the touch-screen display device of FIG.1. FIG. 4 is a cross-sectional view taken along a line I-I′ of FIG. 3.

Referring to FIGS. 3 and 4, the touch-screen display device includes the display panel 300 and the touch panel 700 is attached to the display panel 300.

The display panel 300 includes the first lower substrate 100 and the first upper substrate 200. The display panel 300 has the display area DA on which an image is displayed and the peripheral area PA that surrounds the display area DA. The first lower substrate 100 corresponding to the exposure area EA is attached to the reinforcing member 600. The exposure area EA is a portion of the peripheral area PA of the first lower substrate 100, in which the first upper substrate 200 is not overlapped with the display panel 300.

A distance d between the display panel 300 and the touch panel 700 corresponds to a thickness of the first upper substrate 200. Thus, the reinforcing member 600 is disposed in the exposure area EA in which the first upper substrate 200 is not overlapped with the display panel 300 to maintain the distance d between the display panel 300 and the touch panel 700.

In addition, the reinforcing member 600 is disposed in an area adjacent to the TSP terminal portion 110, the FPC terminal portion 120 and the IC terminal portion 130. The reinforcing member 600 protects the TSP terminal portion 110, the FPC terminal portion 120 and the IC terminal portion 130 from static electricity.

Hereinafter, the same reference numerals will be used to refer to the same or like parts as those described in the first example embodiment and any further repetitive explanation concerning the above elements will be omitted.

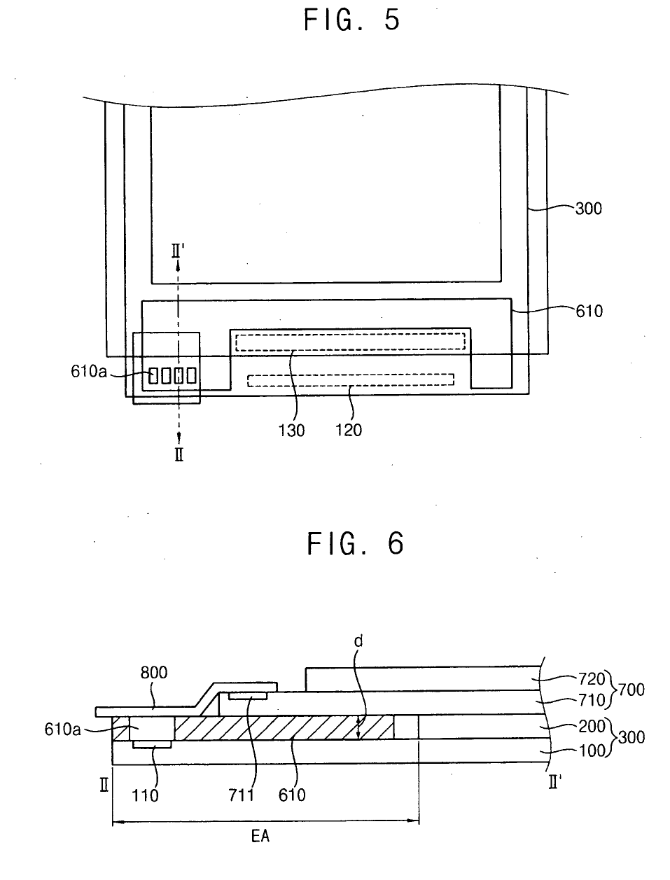

FIG. 5 is a plan view illustrating a touch-screen display device according to a second exemplary embodiment of the present invention. FIG. 6 is a cross-sectional view taken along a line II-II′ of FIG. 5.

Referring to FIGS. 2, 5 and 6, a touch-screen display device according to a second exemplary embodiment of the present invention includes a reinforcing member 610.

For example, the reinforcing member 610 includes a conductive terminal portion 610a and is an adhesive tape having an adhesive material that is disposed on at least one surface of the reinforcing member 610.

The reinforcing member 610 covers a TSP terminal portion 110 for mounting a sub-FPCB 800. The reinforcing member 610 is attached between a first lower substrate 100 and the sub-FPCB 800 in an area adjacent to an IC terminal portion 130 for mounting a driving chip 400 and an FPC terminal portion 120 for mounting a main FPCB 500.

The conductive terminal portion 610a is inserted in a hole that is formed in the reinforcing member 610. An upper surface of the conductive terminal portion 610a makes contact with the sub-FPCB 800 and a lower surface of the conductive terminal portion 610a makes contact with the TSP terminal portion 110 of a display panel 300, and thus the conductive terminal portion 610a electrically connects the TSP terminal portion 110 with the sub-FPCB 800.

The reinforcing member 610 is disposed on an exposure area EA of the first lower substrate 100. The first lower substrate 100 is exposed in the exposure area EA by a first upper substrate 200.

The reinforcing member 610 is attached to the first lower substrate 100 corresponding to the exposure area EA, thereby maintaining the distance d between the display panel 300 and a touch panel 700. Thus, the reinforcing member 610 buffers against external impacts in an assembly process to prevent damage to the touch-screen display device by external impacts.

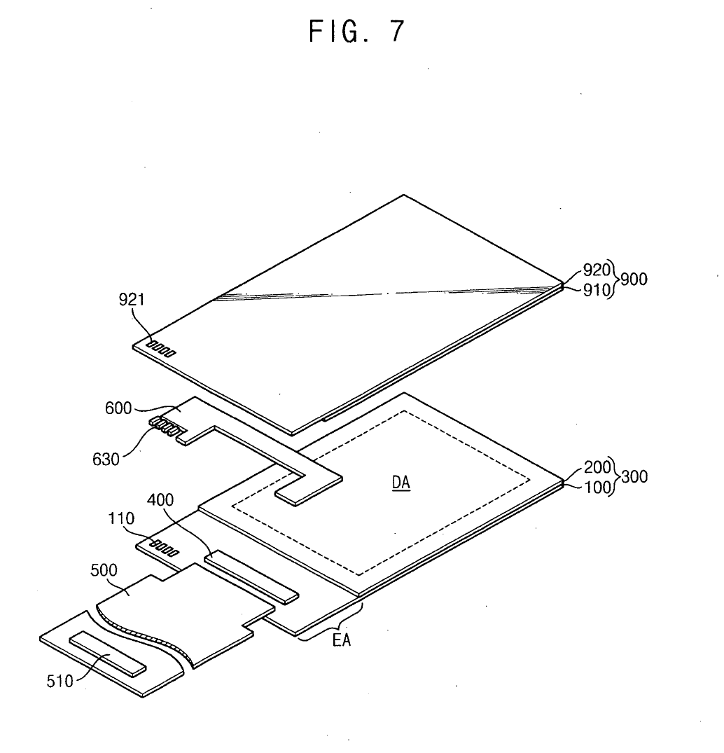

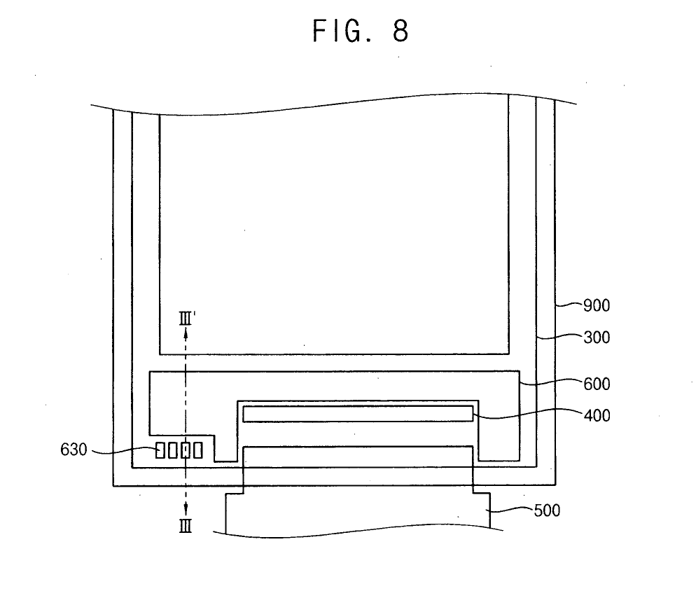

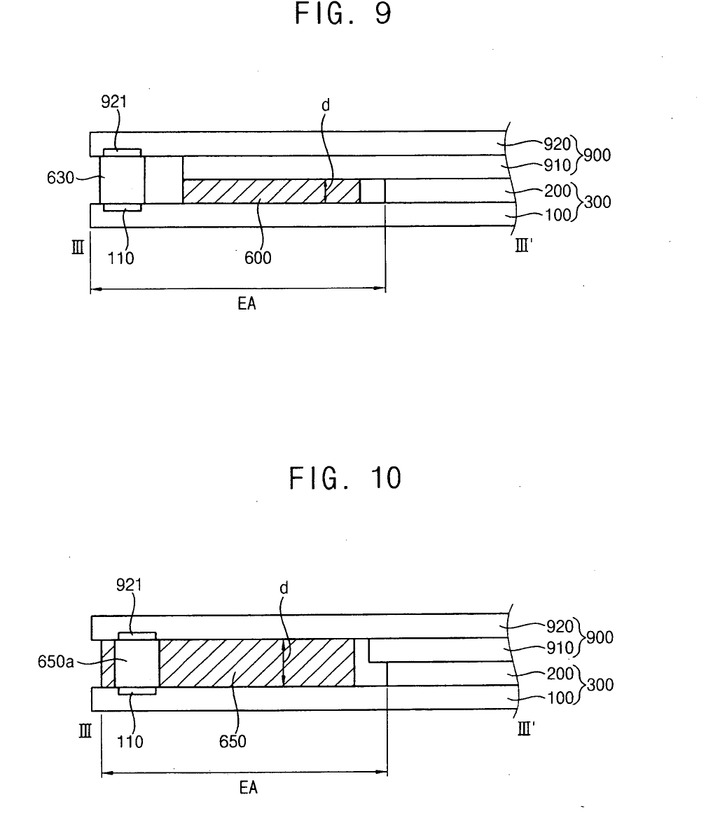

FIG. 7 is an exploded perspective view illustrating a touch-screen display device according to a third exemplary embodiment of the present invention. FIG. 8 is plan view illustrating the touch-screen display device of FIG. 7. FIG. 9 is a cross-sectional view taken along a line III-III′ of FIG. 8.

Referring to FIGS. 2, 7, 8 and 9, a touch-screen display device according to a third exemplary embodiment of the present invention includes a display panel 300, a driving chip 400, a main FPCB 500, a reinforcing member 600, a conductive adhesive member 630 and a touch panel 900.

The display panel 300 includes a first lower substrate 100 and a first upper substrate 200. The first lower substrate 100 has a display area DA and a peripheral area PA that surrounds the display area DA. Gate lines GL, data lines DL crossing the gate lines GL and pixel portions are formed in the display area DA.

A TSP terminal portion 110, an FPC terminal portion 120 and an IC terminal portion 130 are formed in the peripheral area PA corresponding to the end of the source lines, as shown in FIG. 2.

The driving chip 400 is disposed on the IC terminal portion 130. The IC terminal portion 130 and the driving chip 400 are electrically connected with each other by an ACF.

The main FPCB 500 is disposed on the FPC terminal portion 120. The FPC terminal portion 120 and the main FPCB 500 are electrically connected with each other by the ACF.

The reinforcing member 600 is disposed on an exposure area EA, which is a peripheral area of the first lower substrate 100. The first lower substrate 100 is not overlapped with the first upper substrate 200 in the exposure area EA. An adhesive material is formed on at least one surface of the reinforcing member. For example, the reinforcing member 600 is an adhesive tape type.

The reinforcing member 600 is attached to the first lower substrate 100 corresponding to the exposure area EA, thereby maintaining the distance d between the display panel 300 and the touch panel 900. Thus, the reinforcing member 600 buffers against external impacts in an assembly process, to prevent damage to the touch-screen display device by external impacts.

In addition, the reinforcing member 600 is disposed between the first lower substrate 100 and the touch panel 900 in an area adjacent to the TSP terminal portion 110, the FPC terminal portion 120 and the IC terminal portion 130. The reinforcing member 600 protects the TSP terminal portion 110, the FPC terminal portion 120 and the IC terminal portion 130 from static electricity.

The conductive adhesive member 630 electrically connects the TSP terminal portion 110 of the display panel 300 with a signal terminal portion 921 of the touch panel 900. For example, the conductive adhesive member 630 is a double-sided adhesive tape.

The signal terminal portion 921 of the touch panel 900 is attached to an upper surface of the conductive adhesive member 630, and the TSP terminal portion 110 of the display panel 300 is attached to a lower surface of the conductive adhesive member 630.

The touch panel 900 includes a second lower substrate 910 and a second upper substrate 920, and generates a coordinate signal corresponding to a touch position by a resistive overlay. For example, the second lower substrate 910 includes a lower plate electrode that generates a coordinate signal X of the touch position. The second upper substrate 920 includes an upper electrode that generates a coordinate signal Y of the touch position. The coordinate signal is transmitted to the signal terminal portion 921 formed on the second upper substrate 920.

The signal terminal portion 921 is formed on a portion of the touch panel 900 facing the TSP terminal portion 110 of the display panel 300. For example, the signal terminal portion 921 is formed on a portion of the second upper substrate 920 facing the TSP terminal portion 110 of the display panel 300.

The touch-screen display device of the present exemplary embodiment does not require the sub-FPCB 800 shown in FIGS. 1 to 6, and the TSP terminal portion 110 and the signal terminal portion 921 are electrically connected with each other by the conductive adhesive member 630.

FIG. 10 is a cross-sectional view illustrating a touch-screen display device according to a fourth exemplary embodiment of the present invention.

Referring to FIGS. 8 and 10, a touch-screen display device according to a fourth exemplary embodiment includes a reinforcing member 650.

For example, the reinforcing member 650 includes a conductive terminal portion 650a, and includes an adhesive tape having an adhesion material that is formed on at least one surface of the reinforcing member 650.

The reinforcing member 650 covers a TSP terminal portion 110 of a display panel 300. The reinforcing member 650 is disposed in an area adjacent to the IC terminal portion 130 and the FPC terminal portion 120 under the main FPCB 500. The driving chip 400 is mounted on the IC terminal portion 130. The main FPCB 500 is mounted on the FPC terminal portion 120.

The conductive terminal portion 650a is inserted in a hole that is formed in the reinforcing member 650. An upper surface of the conductive terminal portion 650a is attached to the signal terminal portion 921 of the touch panel 900, and a lower surface of the conductive terminal portion 650a is attached to the TSP terminal portion 110 of the display panel 300. Thus, the conductive terminal portion 650a electrically connects the TSP terminal portion 110 with the signal terminal portion 921 of the touch panel 900.

The reinforcing member 650 is disposed in the exposure area EA of the first lower substrate 100. The first lower substrate 100 is exposed in the exposure area EA by a first upper substrate 200 combined with the first lower substrate 100.

The reinforcing member 650 is attached to the exposure area EA of the first lower substrate 100 to maintain the distance d between the display panel 300 and the touch panel 900. Thus, the reinforcing member 650 buffers against external impacts in an assembly process to prevent damage to the touch-screen display device by the external impacts.

The sub-FPCB 800 shown in FIGS. 1 to 6 may be omitted in the touch-screen display device according to FIGS. 7 to 10, so that manufacturing costs of the touch-screen display device of FIGS. 7 to 10 may be smaller than that of the touch-screen display device of FIGS. 1 to 6.

As described above, according to the present invention, a TCP terminal portion is formed on a display panel, which is electrically connected to a signal terminal portion outputting a coordinate signal detected from a touch panel. Thus, the coordinate signal is directly transmitted to a main FPCB, so that the coordinate signal may be stably transmitted.

In addition, damage to the touch-screen display device, such as a crack, a cutting of the FPCB that connects the signal terminal portion of the touch panel with the main FPCB, etc., may be prevented in an assembly process. In addition, manufacturing costs of the touch-screen display device may be decreased.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A touch-screen display device comprising:
a touch panel having a first side and a second side, said touch panel including a signal terminal portion transmitting a coordinate signal corresponding to a touch position; and
a display panel disposed adjacent to the second side of the touch panel, the display panel having a display area in which an image is displayed and a peripheral area surrounding the display area, a first terminal portion of the display panel being disposed in the peripheral area and electrically connected to the signal terminal portion.

2. The touch-screen display device of claim 1, further comprising a main flexible printed circuit board (FPCB) electrically connected to the display panel to transmit the coordinate signal corresponding to a touch position to a main driving circuit that is disposed on the display panel.

3. The touch-screen display device of claim 2, wherein the display panel further comprises a second terminal portion electrically connected to the first terminal portion and electrically attached to the main FPCB.

4. The touch-screen display device of claim 1, wherein the display panel comprises a first lower substrate including a gate line and a data line crossing the gate line, and a first upper substrate combined with the first substrate, and the touch panel comprises a second lower substrate and a second upper substrate combined with the second lower substrate.

5. The touch-screen display device of claim 4, wherein the first terminal portion is formed on the first substrate.

6. The touch-screen display device of claim 5, further comprising a reinforcing member disposed on a portion of the first substrate, which is not overlapped with the first upper substrate, to maintain a distance between the touch panel and the display panel.

7. The touch-screen display device of claim 6, wherein the reinforcing member is disposed in the peripheral area, in which the first terminal portion is formed, to protect the first terminal from static electricity

8. The touch-screen display device of claim 7, further comprising a sub-FPCB including a first end electrically connected to the first terminal portion and a second end electrically connected to the signal terminal portion.

9. The touch-screen display device of claim 8, wherein the signal terminal portion is formed on the second substrate of the touch panel.

10. The touch-screen display device of claim 8, wherein the reinforcing member comprises a conductive terminal portion electrically attached to the first terminal portion.

11. The touch-screen display device of claim 10, wherein the conductive terminal portion has a first surface attached to the first terminal portion and a second surface attached to the second end of the sub-FPCB.

12. The touch-screen display device of claim 7, further comprising a conductive adhesive member including a first surface attached to the first terminal portion of the display panel and a second surface attached to the signal terminal portion of the touch panel.

13. The touch-screen display device of claim 12, wherein the signal terminal portion is formed on the second substrate of the touch panel.

14. The touch-screen display device of claim 13, wherein the reinforcing member further comprises a conductive terminal portion attached to the first terminal portion.

15. The touch-screen display device of claim 14, wherein the conductive terminal portion has a first surface attached to the first terminal portion and a second surface attached to the signal terminal portion.
